(19) United States
(12) Patent Application Publication
(10) Pub. No.: US 2007/0100732 A1
(43) Pub. Date: May 3, 2007

(54) System and method for aggregation of implied bids and offers for short-term interest rate futures and options

(76) Inventors: Mark Ibbotson, London (GB); Declan Ward, London (GB); Amanda Sudworth, London (GB); Andrew Robins, London (GB)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/260,492

(22) Filed: Oct. 28, 2005

(51) Int. Cl. G06Q 40/00

(52) U.S. Cl. 705/37

(57) ABSTRACT

A method and system for facilitating trading of financial products is provided. The method includes receiving bids and/or offers for a financial product and aggregating bids and offers that are at the same price level. For financial products that include calendar spreads, such as short-term interest rate futures or options, bids and/or offers may be implied in or implied out of other bids and offers by combining them appropriately. When an offer or bid having a matching price level to the aggregated bid or offer is received, the aggregated bid or offer is divided in a prorated proportion based on the number of lots in the matching offer or bid and based on the numbers of lots in the individual bids and offers that make up the aggregated bid or offer. Trades are then executed using the matching offers or bids and the corresponding prorated portions of the original bids or offers.

### BACKGROUND OF THE INVENTION

1. Field of the Invention

The present invention relates to the field of financial markets. More particularly, the invention relates to the trading of financial instruments which have multiple quarterly maturity months, stretching out several years, such as the Euribor futures market, the Eurodollar futures market, and the Short Sterling futures market.

2. Related Art

Volatility and uncertainty are ever present in today's financial markets, not least in the interest rate markets. In the face of this type of uncertainty, treasurers and fund managers are increasingly advised to consider methods of managing their exposure to sharp movements in the financial markets. Short Term Interest Rate (STIR) futures and options can provide the flexibility and security required.

Treasurers, fund managers and other market participants have a number of choices available to them to help them manage their interest rate exposure. This may be accomplished either by using exchange-traded products, like futures and options contracts, or over-the-counter (OTC) products, such as swaps, Forward Rate Agreements (FRAs), caps, and floors, together with the underlying cash markets themselves. Indeed, successful players in today's volatile markets typically employ the full range of available risk management and trading strategies.

Exchange-traded futures and options contracts offer market participants not only a high degree of versatility in their use, but also significant advantages as strategic instruments, especially when complemented by OTC derivative and cash market financial instruments. Indeed, when used effectively, exchange-traded futures and options contracts, in conjunction with cash market and OTC derivative instruments, can enhance returns, reduce risks and manage interest rate risks with greater certainty, precision and economy.

A derivative financial product refers to any financial product that derives from another financial product, usually (but not always) the underlying cash markets. STIR futures, as derivative products, derive from the underlying cash money markets.

A futures contract is a legally binding agreement, concerned with the buying, or selling, of a standardized product, at a fixed price, for cash settlement or physical delivery on a given future date. In the case of STIR futures, the standardized product is short-term interest rates. STIR futures contracts derive from the cash inter-bank markets, and are concerned with the trading of the implied value of the three-month LIBOR (£ and CHF), Euribor ( [symbol] ), Eurodollar ($) or TIBOR (Yen). Currently, for example, Euronext.liffe makes the following STIR futures available for trading, as shown below in Table 1:

TABLE 1
STIR Futures Contracts Specifications on Euronext.liffe

| | Euroswiss | Eurodollar | Euribor | Euroyen | Short Sterling |
|---|---|---|---|---|---|
| Unit of Trading | SFr1 m | US$1 m | [symbol] 1 m | Euroyen100 m | £500,000 |
| Delivery Months | March, June, September, December (plus serial) | | | | |
| Last Trading Day | Two business days prior to third Wednesday | | | | Third Wed |
| Quotation | 100.00 minus rate of interest | | | | |
| Price Movement | 0.01 | 0.005 | 0.005 | 0.005 | 0.01 |
| (Value) | SFr 25 | $12.50 | [symbol] 12.50 | Y1250 | £12.50 |

A traders enters an order into an electronic STIR futures market by entering a “bid” (i.e., an intention to buy) or an “offer” (i.e., an intention to sell) into the system. When prices for bids and offers are matched, a trade confirmation is generated by the electronic trading platform. Users of the system may enter bids or offers into individual contract months, or directly into the strategy markets, as defined below. At the end of trading, the exchange publishes a settlement price for each individual contract month on each STIR product. Settlement prices are defined by the exchange, and take into account price at which trades are occurring, and the relative weight of bids and offers in the marketplace. A futures contract has a closing, or settlement price, every day at the end of trading, but the final settlement price on the Last Trading Day when the contract expires, is known as the Exchange Delivery Settlement Price (EDSP).

Futures (and options) can be used for three main purposes: hedging, speculating, and arbitraging. A hedger uses the market to offset, cover, or protect, either an actual underlying position, or a perceived requirement. A true hedger therefore, does not seek to profit from a hedge, but simply takes a position as a form of insurance, to cover a position in one market, or product, with an equal and opposite position in another. A “perfect hedge” should therefore result in a profit in one position being fully offset by an equal and opposite loss in the other. In general, protection against a fall in interest rates can be achieved by buying futures; i.e., a so-called “long” hedge. Protection against a rise in interest rates can be achieved by selling futures, i.e., a so-called “short” hedge.

A speculator uses the STIR market to simply “buy low” and “sell high” or vice versa, thereby hoping to make a profit from the difference in price. A speculator therefore has no real need of the underlying product concerned and can speculate on any contract. However, speculators perform the useful purpose of providing much needed liquidity (i.e., a plurality of buyers and sellers at any given price) to any futures contract.

Products that have identical characteristics and so are perfect substitutes for each other should theoretically trade at the same price. If they do not, a risk-free profit can be obtained by simultaneously selling the higher-priced one and buying the lower-priced one. An “arbitrageur” is therefore someone who uses the markets to take advantage of pricing anomalies that may occur. Such an anomaly could occur between two inter-related products on an exchange, or between two inter-related products on two different exchanges, or between an exchange-traded product and the same product trading in the OTC market. Importantly, with respect to arbitrage, it can only be defined as “pure” arbitrage if both sides of the transaction are dealt simultaneously (i.e., there is no risk at any time). Any delay involved, such as, for example, waiting for one side to move more than the other, is known in the markets as “legging risk” or “lifting a leg”. These delay scenarios are not pure arbitrage, because an element of risk has thereby been introduced.

Conventionally, there have been systems for calculating and holding a full implied depth order book, and supporting products which traded on a pro-rata algorithm. In so doing, these systems have migrated Short Term Interest Rate Futures contracts from open outcry trading onto a fully electronic platform, hence reducing the cost of doing business and extending the distribution of the markets supported by the system. As the volume of traders, volume of business and distribution of these markets has grown over the years, the number of implied calculations such systems have become cumbersome. In addition, the greater adoption of strategy trading and the explosive growth in the use of automated trading tools have placed an ever-increasing burden on such systems to perform more complex calculations, and to maintain, in real-time, the full implied order book and the relationship between the strategy markets. At times when the order book is particularly complex, this can translate into individual traders perceiving delays—i.e., responses from the system that can take greater than 1 second. Accordingly, the present invention is intended to address these shortcomings.

### SUMMARY OF THE INVENTION

In one aspect, the invention provides a system for facilitating trading of financial products. The system includes a server at which the financial products are actively traded and an interface in communication with the server. The interface is configured to enable at least one of bid and an offer for a financial product to be entered. The server is configured to receive bids and offers for each financial product via the interface. Each bid and offer includes a price and a number of lots. When, for a first product, the server receives a first bid for a first number of lots at a first time and a second bid for a second number of lots at a second time, the first bid having a same price as the second bid, the server is configured to automatically aggregate the two received bids together. When the server then receives an offer for the first product having a third number of lots and the same price as the first and second bids at a third time, the third time being after both the first time and the second time, and the third number of lots being less than a sum of the first and second numbers of lots, the server is configured to automatically divide the received offer into a first partial offer and a second partial offer by respectively allotting the third number of lots into a fourth number of lots and a fifth number of lots. The fourth and fifth numbers are respectively determined to be in a same relative proportion as the first and second numbers. A sum of the fourth and fifth numbers is equal to the third number. The server is further configured to automatically match the first bid to the first partial offer and to match the second bid to the second partial offer, and to execute trades respectively corresponding to the matched bids and partial offers.

When a trade is executed such that, for a given bid, a number of lots actually traded is less than the number of lots included in the given bid, the server may be configured to automatically retain an open bid including a remaining number of untraded lots. At least one of the financial products may include a number of deliveries of a short term interest rate (STIR) futures contract. The server may be further configured to automatically combine received bids and offers for the STIR futures contract into an implied bid. The implied bid may include one of the first bid or the second bid. The server may also be further configured to automatically combine received bids and offers for the STIR futures contract into an implied offer. The implied offer may include the received offer. The at least one financial product may be selected from the group consisting of strips, packs, bundles, and condors.

In another aspect, the invention provides a system for facilitating trading of financial products. The system includes a server at which the financial products are actively traded, and an interface in communication with the server. The interface is configured to enable at least one of a bid and an offer for a financial product to be entered. The server is configured to receive bids and offers for each financial product via the interface. Each bid or offer includes a price and a number of lots. When, for a first product, the server receives a first offer for a first number of lots at a first time and a second offer for a second number of lots at a second time, the first offer having a same price as the second offer, the server is configured to automatically aggregate the offers together. When the server then receives a bid for the first product having a third number of lots and the same price as the first and second offers at a third time, the third time being after both the first time and the second time, and the third number of lots being less than a sum of the first and second numbers of lots, the server is configured to automatically divide the received bid into a first partial bid and a second partial bid by respectively allotting the third number of lots into a fourth number of lots and a fifth number of lots. The fourth and fifth numbers are respectively determined to be in a same relative proportion as the first and second numbers. A sum of the fourth and fifth numbers is equal to the third number. The server is further configured to automatically match the first offer to the first partial bid and to match the second offer to the second partial bid, and to execute trades respectively corresponding to the matched offers and partial bids.

When a trade is executed such that, for a given offer, a number of lots actually traded is less than the number of lots included in the given offer, the server may be configured to automatically retain an open offer including a remaining number of untraded lots. At least one of the financial products may include a number of deliveries of a short term interest rate (STIR) futures contract. The server may be further configured to automatically combine received bids and offers for the STIR futures contract into an implied offer. The implied offer may include one of the first offer or the second offer. The server may also be further configured to automatically combine received bids and offers for the STIR futures contract into an implied bid. The implied bid may include the received bid. The at least one financial product may be selected from the group consisting of strips, packs, bundles, and condors.

In yet another aspect, the invention provides a system for facilitating trading of financial products. The system includes a server at which the financial products are actively traded and an interface in communication with the server. The interface is configured to enable at least one of a bid and an offer for a financial product to be entered. The server is configured to receive bids and offers for each financial product via the interface, each bid and offer including a price and a number of lots. When, for a first product, the server receives N bids at N different times, each of the N bids having a same price, the server is configured to automatically aggregate the N bids. When the server receives an offer for the first product after all N bids have been received, the offer including a number of lots that is less than a sum of the numbers of lots of the N received bids, the server is configured to automatically divide the received offer into N partial offers by respectively allotting the offered number of lots according to a same relative proportion as the corresponding numbers of lots included in each of the N bids. The server is further configured to automatically match each of the N bids to a corresponding one of the N partial offers, and to execute trades corresponding to the matched bids and partial offers.

When a trade is executed such that, for a given bid, a number of lots actually traded is less than the number of lots included in the given bid, the server may be configured to automatically retain an open bid including a remaining number of untraded lots. At least one of the financial products may include a number of deliveries of a short term interest rate (STIR) futures contract. The server may be further configured to automatically combine received bids and offers for the STIR futures contract into an implied bid. The implied bid may include one of the N received bids. The server may also be further configured to automatically combine received bids and offers for the STIR futures contract into an implied offer. The implied offer may include the received offer. The at least one financial product may be selected from the group consisting of strips, packs, bundles, and condors.

In still another aspect, a system for facilitating trading of financial products is provided. The system includes a server at which the financial products are actively traded and an interface in communication with the server. The interface is configured to enable at least one of a bid and an offer for a financial product to be entered. The server is configured to receive bids and offers for each financial product via the interface. Each bid or offer includes a price and a number of lots. When, for a first product, the server receives N offers at N different times, each of the N offers having a same price, the server is configured to automatically aggregate the received offers. When the server receives a bid for the first product after all N offers have been received, the bid including a number of lots that is less than a sum of the numbers of lots of the N received offers, the server is configured to automatically divide the received bid into N partial bids by respectively allotting the bidded number of lots according to a same relative proportion as the corresponding numbers of lots included in each of the N offers. The server is further configured to automatically match each of the N offers to a corresponding one of the N partial bids, and to execute trades corresponding to the matched offers and partial bids.

When a trade is executed such that, for a given offer, a number of lots actually traded is less than the number of lots included in the given offer, the server may be configured to automatically retain an open offer including a remaining number of untraded lots. At least one of the financial products may include a number of deliveries of a short term interest rate (STIR) futures contract. The server may be further configured to combine received bids and offers for the STIR futures contract into an implied offer. The implied offer may include one of the N received offers. The server may also be further configured to automatically combine received bids and offers for the STIR futures contract into an implied bid. The implied bid may include the received bid. The at least one financial product may be selected from the group consisting of strips, packs, bundles, and condors.

In yet another aspect, the invention provides a method of trading a financial product. The method includes the steps of receiving a first bid for the financial product at a first time, the first bid including a first number of lots and a price; receiving a second bid for the financial product at a second time, the second bid including a second number of lots and a same price as the price included in the first bid; and receiving an offer for the financial product at a third time, the third time occurring after both the first time and the second time. The offer includes a third number of lots and the same price as the price included in each of the first and second bids. The third number is less than a sum of the first and second numbers. The method further includes the step of automatically dividing the received offer into a first partial offer and a second partial offer by allotting the third number of lots into a fourth number of lots and a fifth number of lots. The fourth and fifth numbers are respectively determined to be in a same relative proportion as the first and second numbers. A sum of the fourth and fifth numbers is equal to the third number. The method further includes the steps of automatically matching the first bid to the first partial offer; automatically matching the second bid to the second partial offer; and executing trades corresponding to the matched bids and partial offers.

When a trade is executed such that, for a given bid, a number of lots actually traded is less than the number of lots included in the given bid, the method may further include the step of automatically retaining an open bid including a remaining number of untraded lots. At least one of the financial products comprising a number of deliveries of a short term interest rate (STIR) futures contract. The method may further include the step of automatically combining received bids and offers for the STIR futures contract into an implied bid. The implied bid may include one of the first bid or the second bid. The method may also further include the step of automatically combining received bids and offers for the STIR futures contract into an implied offer. The implied offer may include the received offer. The at least one financial product may be selected from the group consisting of strips, packs, bundles, and condors.

In still another aspect, the invention provides a method of trading a financial product. The method includes the steps of receiving a first offer for the financial product at a first time, the first offer including a first number of lots and a price; receiving a second offer for the financial product at a second time, the second offer including a second number of lots and a same price as the price included in the first offer; and receiving a bid for the financial product at a third time, the third time occurring after both the first time and the second time. The bid includes a third number of lots and the same price as the price included in each of the first and second offers. The third number is less than a sum of the first and second numbers. The method further includes the step of automatically dividing the received bid into a first partial bid and a second partial bid by allotting the third number of lots into a fourth number of lots and a fifth number of lots. The fourth and fifth numbers are respectively determined to be in a same relative proportion as the first and second numbers. A sum of the fourth and fifth numbers is equal to the third-number. The method further includes the steps of automatically matching the first offer to the first partial bid; automatically matching the second offer to the second partial bid; and executing trades corresponding to the matched offers and partial bids.

When a trade is executed such that, for a given offer, a number of lots actually traded is less than the number of lots included in the given offer, the method may further include the step of automatically retaining an open offer including a remaining number of untraded lots. At least one of the financial products may include a number of deliveries of a short term interest rate (STIR) futures contract. The method may further include the step of automatically combining received bids and offers for the STIR futures contract into an implied offer. The implied offer may include one of the first offer or the second offer. The method may also further include the step of automatically combining received bids and offers for the STIR futures contract into an implied bid. The implied bid may include the received bid. The at least one financial product may be selected from the group consisting of strips, packs, bundles, and condors.

In yet another aspect, a method of trading a financial product is provided. The method includes the steps of receiving N bids for the financial product, each of the N bids including a respective number of lots and a same price; and receiving an offer for the financial product after all of the N bids have been received. The offer includes a same price as the price included in each of the N bids and a number of lots that is less than a sum of the numbers of lots included in the N bids. The method further includes the step of automatically dividing the received offer into N partial offers by allotting the offered number of lots according to a same relative proportion as the corresponding numbers of lots included in each of the N bids. The method further includes the steps of automatically matching each of the N bids to a corresponding partial offer; and executing trades corresponding to the matched bids and partial offers.

When a trade is executed such that, for a given bid, a number of lots actually traded is less than the number of lots included in the given bid, the method may further include the step of automatically retaining an open bid including a remaining number of untraded lots. At least one of the financial products may include a number of deliveries of a short term interest rate (STIR) futures contract. The method may further include the step of automatically combining received bids and offers for the STIR futures contract into an implied bid. The implied bid may include one of the N received bids. The method may also further include the step of automatically combining received bids and offers for the STIR futures contract into an implied offer. The implied offer may include the received offer. The at least one financial product may be selected from the group consisting of strips, packs, bundles, and condors.

In still another aspect, the invention provides a method of trading a financial product. The method includes the steps of receiving N offers for the financial product, each of the N offers including a respective number of lots and a same price; and receiving a bid for the financial product after all of the N offers have been received. The bid includes a same price as the price included in each of the N offers and a number of lots that is less than a sum of the numbers of lots included in the N offers. The method further includes the step of automatically dividing the received bid into N partial bids by allotting the offered number of lots according to a same relative proportion as the corresponding numbers of lots included in each of the N offers. The method further includes the steps of automatically matching each of the N offers to a corresponding partial bid; and executing trades corresponding to the matched offers and partial bids.

When a trade is executed such that, for a given offer, a number of lots actually traded is less than the number of lots included in the given offer, the method may further include the step of automatically retaining an open offer including a remaining number of untraded lots. At least one of the financial products may include a number of deliveries of a short term interest rate (STIR) futures contract. The method may further include the step of automatically combining received bids and offers for the STIR futures contract into an implied offer. The implied offer may include one of the N received offers. The method may also further include the step of automatically combining received bids and offers for the STIR futures contract into an implied bid. The implied bid may include the received bid. The at least one financial product may be selected from the group consisting of strips, packs, bundles, and condors.

In yet another aspect, the invention provides a storage medium for storing software for facilitating trading of a financial product. The software is computer-readable. The software includes instructions for causing a computer to receive N bids for the financial product, each of the N bids including a respective number of lots and a same price; and receive an offer for the financial product after all of the N bids have been received. The offer includes a same price as the price included in each of the N bids and a number of lots that is less than a sum of the numbers of lots included in the N bids. The software further includes instructions for causing a computer to divide the received offer into N partial offers by allotting the offered number of lots according to a same relative proportion as the corresponding numbers of lots included in each of the N bids. The software further includes instructions for causing a computer to match each of the N bids to a corresponding partial offer; and execute trades corresponding to the matched bids and partial offers.

When a trade is executed such that, for a given bid, a number of lots actually traded is less than the number of lots included in the given bid, the software may further include instructions for causing a computer to retain an open bid including a remaining number of untraded lots. At least one of the financial products may include a number of deliveries of a short term interest rate (STIR) futures contract. The software may further include instructions for causing a computer to combine received bids and offers for the STIR futures contract into an implied bid. The implied bid may include one of the N received bids. The software may also further include instructions for causing a computer to combine received bids and offers for the STIR futures contract into an implied offer. The implied offer may include the received offer. The at least one financial product may be selected from the group consisting of strips, packs, bundles, and condors.

In still another aspect, the invention provides a storage medium for storing software for facilitating trading of a financial product. The software is computer-readable. The software includes instructions for causing a computer to receive N offers for the financial product, each of the N offers including a respective number of lots and a same price; and receive a bid for the financial product after all of the N offers have been received. The bid includes a same price as the price included in each of the N offers and a number of lots that is less than a sum of the numbers of lots included in the N offers. The software further includes instructions for causing a computer to divide the received bid into N partial bids by allotting the offered number of lots according to a same relative proportion as the corresponding numbers of lots included in each of the N offers. The software further includes instructions for causing a computer to match each of the N offers to a corresponding partial bid; and execute trades corresponding to the matched offers and partial bids.

When a trade is executed such that, for a given offer, a number of lots actually traded is less than the number of lots included in the given offer, the software may further include instructions for causing a computer to retain an open offer including a remaining number of untraded lots. At least one of the financial products may include a number of deliveries of a short term interest rate (STIR) futures contract. The software may further include instructions for causing a computer to combine received bids and offers for the STIR futures contract into an implied offer. The implied offer may include one of the N received offers. The software may also further include instructions for causing a computer to combine received bids and offers for the STIR futures contract into an implied bid. The implied bid may include the received bid. The at least one financial product may be selected from the group consisting of strips, packs, bundles, and condors.

### BRIEF DESCRIPTION OF THE DRAWINGS

FIG. 1 illustrates a block diagram of a system for facilitating trading of equity and index options according to a preferred embodiment of the invention.

FIG. 2 is a flow chart that illustrates a method of facilitating trading of equity and index options according to a preferred embodiment of the invention.

FIG. 3 is a block diagram that illustrates system maintenance of implied prices.

FIG. 4 is a block diagram that illustrates the complexity of maintaining a full implied depth in an order book at the system level.

FIG. 5 is a block diagram that illustrates an effect of timing upon implied trading while maintaining full implied depth.

FIG. 6 is a block diagram that illustrates aggregation of implied orders according to a preferred embodiment of the invention.

### DETAILED DESCRIPTION OF THE INVENTION

The present invention addresses the shortcomings noted above by virtue of a novel implied method of calculation, such that the system “aggregates” every implied order held in the order book. This has a number of benefits to the market, including 1) elimination of the delayed responses perceived by traders, hence improving their trading performance; 2) elimination of any time element within the trading algorithm (described below), hence improving the fairness of distribution of large trades; and 3) reducing traders' desire to enter multiple orders at depth in the marketplace, to take advantage of any time element to trading. As this reduces the complexity of the order book, it has the benefit of improving performance again.

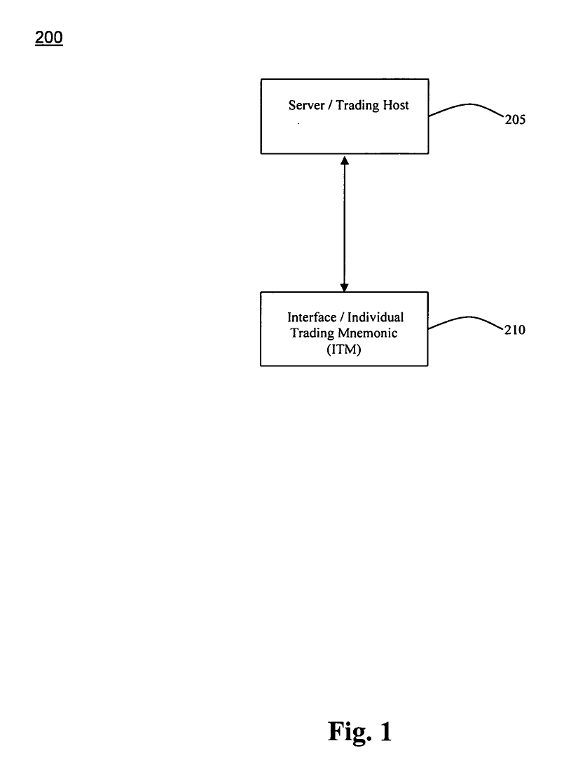

Referring to FIG. 1, a block diagram illustrates an electronic trading system 200 according to a preferred embodiment of the present invention. The system includes one or more servers 205, also referred to as a trading host 205, and one or more interfaces 210, also referred to as an Individual Trading Mnemonic (ITM) 210. The trading host 205 is preferably implemented by the use of one or more general purpose computers, such as, for example, a Sun Microsystems F15k. Each ITM 210 is also preferably implemented by the use of one or more general purpose computers, such as, for example, a typical personal computer manufactured by Dell, Gateway, or Hewlett-Packard. Each of the trading host 205 and the ITM 210 can include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof. The trading host may use its microprocessor to read a computer-readable medium containing software that includes instructions for carrying out one or more of the functions of the trading host 205, as further described below.

Each of the trading host 205 and the ITM 210 can also include computer memory, such as, for example, random-access memory (RAM). However, the computer memory of each of the trading host 205 and the ITM 210 can be any type of computer memory or any other type of electronic storage medium that is located either internally or externally to the trading host 205 or the ITM 210, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), or the like. According to exemplary embodiments, the respective RAM can contain, for example, the operating program for either the trading host 205 or the ITM 210. As will be appreciated based on the following description, the RAM can, for example, be programmed using conventional techniques known to those having ordinary skill in the art of computer programming. The actual source code or object code for carrying out the steps of, for example, a computer program can be stored in the RAM. Each of the trading host 205 and the ITM 210 can also include a database. The database can be any type of computer database for storing, maintaining, and allowing access to electronic information stored therein. The host server 105 preferably resides on a network, such as a local area network (LAN), a wide area network (WAN), or the Internet. The ITM 210 preferably is connected to the network on which the host server resides, thus enabling electronic communications between the trading host 205 and the ITM 210 over a communications connection, whether locally or remotely, such as, for example, an Ethernet connection, an RS-232 connection, or the like.

“Implied-in” strips, packs, bundles and condors are trading strategies, which allow a user to buy or sell several futures contract months, or “legs”, in a single transaction. Derivatives products, which are typically made up of a large number of contracts months (e.g., Short Term Interest Rate (STIR) futures), add real value to large users of the market when they offer trading in strips, packs and bundles, as they allow a long term interest rate futures position to be taken, without undertaking the cost and risk of buying or selling each of the individual contract months—known in the market as “legging risk”. In addition, if market makers are encouraged to submit bids and offers into the pack and bundle markets, often the prices achieved by purchasing a pack or bundle are better than those achieved by buying the individual legs.

The trading host 205 links the price relationships between the legs and the strategy markets, such that changes in the prices of the legs, will imply in tradable strategies in strips, packs, bundles and condors, and make them available for trading in an anonymous electronic market. This will ensure that a fair and orderly market is maintained, particularly during times of high volatility, between the strategy and outright markets.

The vast majority of strip, pack, bundle and condor trading takes place in “Open Outcry” trading in physical trading pits. Calculating and disseminating implied-in strip, pack, bundle, and condor prices will make their transition to electronic futures trading a smoother and more natural process, bringing the benefits of electronic trading to a wider audience: global price distribution, lower costs, and greater liquidity for the entire market.

An electronic trading platform, or exchange, such as trading host 205, may allow market participants to submit orders for STIR futures in the form of individual contract months, also referred to as “outrights”. In addition, an exchange may allow market participants to submit an order as a complete strategy—i.e., a combination of two or more contract months, which are also referred to as “legs”. Those strategies are then quoted in the market as an entire strategy.

For futures contracts in which many different delivery months are available to trade, strategy trading is particularly useful to hedgers. This is because taking a completely hedged position may often involve buying or selling multiple contract months to achieve exposure over a number of years. In general, it is far more efficient to perform these kind of “multi-legged” trades by utilizing the strategy markets.

For example, LIFFE CONNECT®, the trading platform used by Euronext.liffe, currently makes the following trading strategies available for trading STIR futures:
Calendar Spread: Buy one contract in the near month; sell one contract in the far month.
Butterfly: Buy one contract in near month, sell two contracts in the far month, buy one contract in a yet farther month. The gaps between the months do not have to be equal or consecutive.
Condor: Buy one near contract month, sell one far month, sell one further month and buy one still further month. The gaps between the months do not have to be equal or consecutive.
Strip: Buy four or more consecutive quarterly delivery months. Any quarterly delivery month can act as the first month of the strip, so long as there are at least three following months available. Serial months in a contract are ignored and cannot form part of a strip. The number of lots in each leg can vary. Selling the strip involves selling all months in the strip, and vice versa for buying.
Pack: Buy four quarterly delivery months in the same delivery year. LIFFE CONNECT® currently recognizes five packs: White Pack, Red Pack, Green Pack, Blue Pack and Gold Pack. The first month of the White Pack is always the front quarterly month (i.e., the earliest possible future quarterly month). The following packs (i.e., Red, Green, Blue and Gold) must also start with the same quarterly month in following years. The number of lots in each leg of a pack must always be the same.
Bundle: Buy a series of quarterly delivery months of a contract where the first contract in any bundle is the front (i.e., earliest-dated) quarterly delivery month. A bundle is a consecutive series of packs. The first month of a bundle is always the front quarterly month. The number of lots in each leg must be the same. LIFFE CONNECT® currently recognizes four bundles: 2 Year Bundle, 3 Year Bundle, 4 Year Bundle and 5 Year Bundle.

One of the great barriers to migrating complex strategy trading to an electronic platform is that many strategies are generated by “implied” prices. Implied orders are synthetic orders that are generated as a result of the interaction of explicit orders. Implied trading functionality increases liquidity and improves trading opportunities. There are two different forms of implieds—implied-ins and implied-outs. For explicit strategy markets where implied trading functionality applies, the relevant outright contract months can generate implied-in prices into strategy markets. Where these implied-in prices represent the best price for a strategy, they may be traded subject to the trade matching algorithm. The interaction of an explicit strategy order and an outright order can generate an implied-out price in another outright market. Where an implied-out price generated by the electronic platform represents the best price for the outright contract month, the order will be traded subject to the trading algorithm.

An example of an implied-in calendar spread is shown in Table 2 below:

TABLE 2

| | Month | | |
|---|---|---|---|
| | | | December/March |
| | December | March | Strategy |
| Bid | 95.000 | | −0.100 Implied |
| Ask | | 95.100 | |

The purchase of a December/March spread is the equivalent of buying a December quarterly delivery and selling a March quarterly delivery. In this example, two explicit orders are entered. This creates an implied-in strategy bid in December/March of −0.100. This price is calculated and held in the electronic trading platform. An incoming strategy that is entered and matches this price will automatically trade against the explicit outright legs that formed the implied strategy.

As described above, implied-in prices are strategy prices implied into the relevant strategy market based on orders in the outright markets which constitute the strategy's legs. The use of implied-in prices will have the effect of increasing liquidity in the strategy market, because strategy orders that are directly entered will then trade with strategy orders which have been generated by the host from the more numerous outright orders.

The trading host 205 features a number of trading algorithms, which have been established to provide an active and fair market. An appropriate matching algorithm is assigned to each contract traded on the system. For STIR products, the algorithm applied is referred to hereinafter as the pro-rata algorithm. With all trading algorithms, the highest bid or the lowest offer has priority over other orders at different prices. In the simplest terms, the pro-rata algorithm divides incoming business between all orders at the best market price level. The volume of business allocated to each trader at the best price is proportionate to the amount of volume they have in the market at that price. The system calculates this in the following order:

A match list is created—i.e., a list of all counterparties to the trade;

The tradeable volume is calculated;

The pro-rata factor is calculated;

The tradeable volume is allocated to all counterparties.

Referring to Table 3 below, an example of the pro-rata algorithm is shown.

TABLE 3
Match list

| Bid Vol | | Pro- | Factor | | Tradeable |
|---|---|---|---|---|---|
| (match | | rata | Order | | volume |
| list) | Trader | factor | Size | Rounding | Allocation |
| 70 | AAA | 0.7 | 16.1 | 16 | 16 |
| 23 | BBB | 0.23 | 5.29 | 5 | 5 |
| 1 | CCC | 0.01 | 0.23 | 1 | 1 |
| 1 | DDD | 0.01 | 0.23 | 1 | 1 |
| 1 | EEE | 0.01 | 0.23 | 1 | 0 |
| 1 | FFF | 0.01 | 0.23 | 1 | 0 |
| 1 | GGG | 0.01 | 0.23 | 1 | 0 |
| 1 | HHH | 0.01 | 0.23 | 1 | 0 |
| 1 | III | 0.01 | 0.23 | 1 | 0 |
| Total | | | | Total | Total |
| 100 | | | | 28 | 23 |

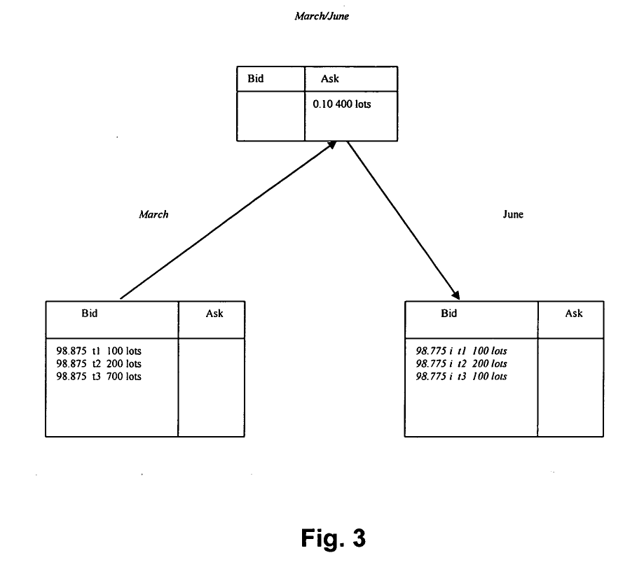

As described above, the system maintains, in a unique queue, every implied order which is generated through the inter-action of explicit orders. Referring to FIG. 3, a graphical illustration of the maintenance of implied prices is shown. In this example, three explicit orders, at price 98.875, have been input into the March Bid, at times t1, t2 and t3 for 100, 200 and 700 lots respectively. In addition, a explicit spread has been input into the March/June calendar spread market, of 0.10 for 400 lots. The inter-action between the March and March/June spread implies out three orders into June bid, each at price 98.775. However, it is noted that order t3 in June has a volume of 100 lots, which is the maximum residual allowed from the March/June spread order. From the point of view of the trader, the implied orders within the June contract are firm, tradeable prices.

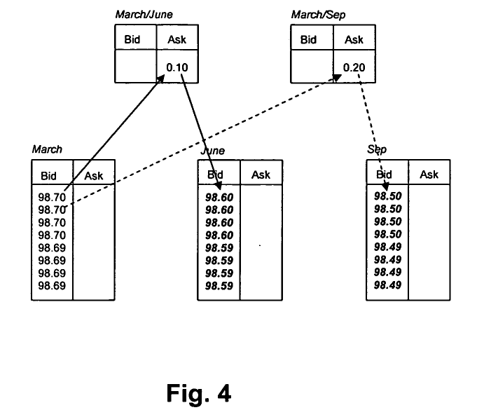

Referring to FIG. 4, another block diagram illustrates the complexity of maintaining a full implied depth. Typically, many differing price levels are maintained within market depth, i.e., traders will enter prices which are not at the “best bid and offer” price levels. These are termed as “resting orders”, and are entered in the hope the market will move in their direction, and thus trade. In addition, the trading host 205 offers not only consecutive quarterly calendar spreads (i.e., March/June, June/September, September/December), but also many non-consecutive spreads, such as, for example, March/September, March/December, June/December, etc. All of the implied relationships, between all possibilities of calendar spreads, must be maintained at all times at the trading host 205 level. This causes a considerable burden on processing, especially during times when the market either has a large number of incoming orders, or has a high level of complexity within the order book. Large numbers of incoming orders can often be generated by automated tools which may be contingent on movements in other related markets. High levels of complexity within the order book may be caused, for example, by traders who have entered multiple resting orders, a number of which may be left in the trading host 205 overnight (i.e., “Good Till Cancelled” orders, or GTCs).

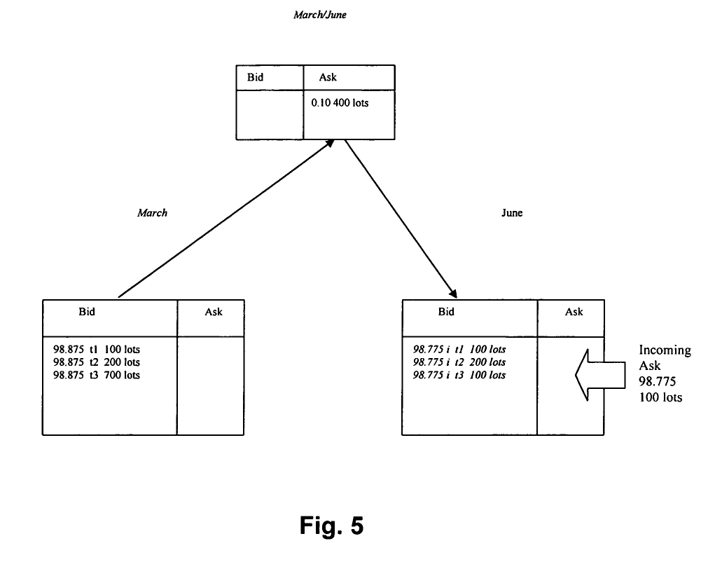

Referring to FIG. 5, maintaining full implied depth has a further impact on the pro-rata trading algorithm, in that it introduces an element of timing for a given price (i.e., First In First Out) into situations where implied trading takes place. While the trading host 205 maintains the full implied depth, it also retains the time each unique implied order was generated, and this can produce some unusual results.

TABLE 4

| Order | Original Volume | Traded Volume |
|---|---|---|
| t1 | 100 | 25 |
| t2 | 200 | 50 |
| t3 | 700 | 25 |

Referring also to Table 4 above, the concept of a trade with the implied out orders in the June contract is illustrated. An Ask for 100 lots at the market price trades immediately. However, the allocation of the trades is not pure pro-rata, because the trading host 205 retains the time information that shows that the explicit orders in the March contract (which will trade via the relationship with the March/June calendar spread) were input at times t1, t2, and t3. The allocation therefore is “time pro-rata”, which gives a distinct advantage to orders t1 and t2, which had lower original order volume than t3, but achieved a better “fill”. Accordingly, the allocation of orders is pro-rata to explicit and implied orders at the best price, but “time pro-rata” to all implied “legs”.

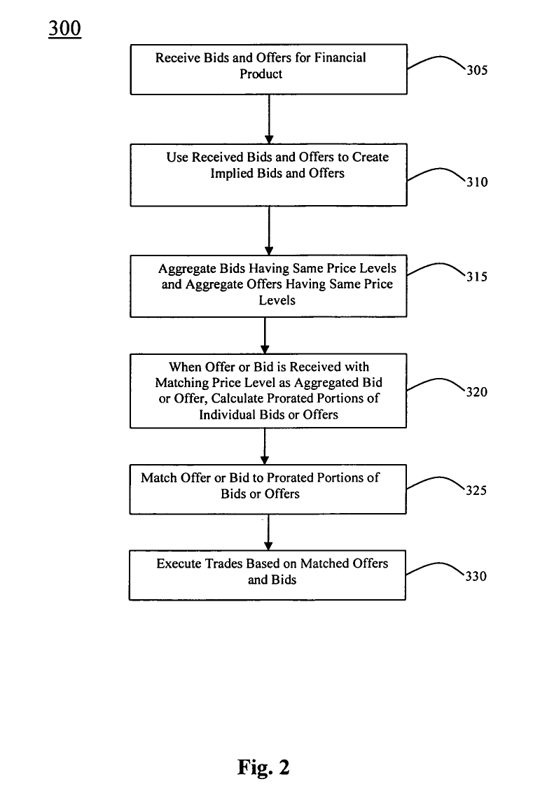

Referring to FIG. 2, a flow chart 300 illustrates a method of facilitating trading of STIR futures and other financial products according to a preferred embodiment of the invention. In the first step 305, the trading host 205 receives bids and offers for a variety of financial products. Each bid or offer includes a price, a number of lots, and a time at which the bid or offer is received. At step 310, the trading host 205 uses received bids and offers to imply in or imply out bids or offers, as previously described. At step 315, for any given financial product, the trading host 205 aggregates received bids having the same price level, and also aggregates received offers having the same price level. Notably, the aggregation of bids and offers at step 315 occurs regardless of when the bids or offers are received. Then, at step 320, when an offer or bid is received that would match an aggregated bid or offer, the trading host 205 calculates prorated portions of each of the individual bids or offers that constitute the aggregated bid or offer, based on the number of lots in the received offer or bid. At step 325, the trading host 205 matches the received offer or bid with the respective prorated portions of the individual bids or offers. Finally, at step 30, the trading host 330 executes trades based on the matching offers and bids.

Through the use of the pro-rata algorithm, the trading host 205 aggregates every implied order held in the order book. This has a number of benefits to the market, including the following:
Aggregation of implied orders effectively eliminates the delayed system responses perceived by traders, because the trading host 205 no longer maintains each separate implied order in time order. Instead, the trading host 205 aggregates all orders at the same price level, and performs the pro-rata calculations at the point of trade, rather than at the point of order entry. Prior to implementation of aggregation of orders, for example, an order rate of over 60 messages per second into the Euribor futures contract had typically caused delays of greater than 1 second. Such a lengthy delay is typically noticed by traders. However using aggregation of implied orders, an order rate of 250 messages per second would cause a system delay of approximately 0.04 seconds, which is much shorter and much more difficult to detect by the human eye.
Aggregation of implied orders eliminates the use of “time pro-rata” within the trading algorithm, thus improving the fairness of distribution of large trades. This is because once the aggregation of implied prices has taken place, the trading host 205 no longer applies any time element to the orders to which it distributes volume.
In turn, the elimination of the time element has the effect of further reducing the likelihood that traders will enter multiple orders at depth in the marketplace. Typically, traders have used this strategy to take advantage of any time element to trading. For example, the entry of GTC orders before market close has been a popular trading strategy, as an attempt to gain a perceived time advantage at the start of trading the following day. As traders move away from this trading strategy, the complexity of the order book will likely be reduced, thus yielding a further performance improvement.
Aggregation of implied orders also enables the system to introduce more functionality at the trading host 205 level which will improve the quality of the market. For example, the trading host 205 can make various different types of financial products available for trading, such as implied-in strips, packs, bundles and condors, as defined above.

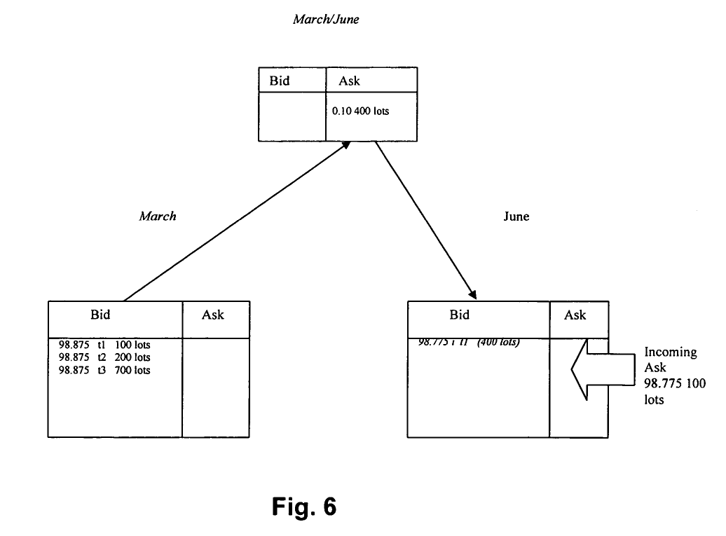

Referring to FIG. 6, an example of aggregation of implied orders is shown. Referring also to Table 5 below, the incoming order in the June Euribor future of 100 lots at 98.775 will result in the following trading volume allocation:

TABLE 5

| Order | Original Volume | Traded Volume |
|---|---|---|
| t1 | 100 | 10 |
| t2 | 200 | 20 |
| t3 | 700 | 70 |

The above example is exactly the same as that shown in FIG. 6, with the exception that the implied out orders in the June contract have been aggregated by the system. This aggregation results in a pure pro rata allocation to orders t1, t2 and t3; hence, the largest “fill” goes to order t3.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A system for facilitating trading of financial products, the system comprising:
a server at which the financial products are actively traded; and
an interface in communication with the server, the interface being configured to enable at least one of a bid and an offer for a financial product to be entered,
wherein the server is configured to receive bids and offers for each financial product via the interface, each bid or offer including a price and a number of lots, and
when, for a first product, the server receives a first bid for a first number of lots at a first time and a second bid for a second number of lots at a second time, the first bid having a same price as the second bid, and when the server receives an offer for the first product having a third number of lots and the same price as the first and second bids at a third time, the third time being after both the first time and the second time, and the third number of lots being less than a sum of the first and second numbers of lots, the server is configured to divide the received offer into a first partial offer and a second partial offer by respectively allotting the third number of lots into a fourth number of lots and a fifth number of lots, wherein the fourth and fifth numbers are respectively determined to be in a same relative proportion as the first and second numbers, and wherein a sum of the fourth and fifth numbers is equal to the third number; and
wherein the server is further configured to match the first bid to the first partial offer and to match the second bid to the second partial offer, and to execute trades respectively corresponding to the matched bids and partial offers.

2. The system of claim 1, wherein when a trade is executed such that, for a given bid, a number of lots actually traded is less than the number of lots included in the given bid, the server is configured to retain an open bid including a remaining number of untraded lots.

3. The system of claim 1, at least one of the financial products comprising a number of deliveries of a short term interest rate (STIR) futures contract, wherein the server is further configured to combine received bids and offers for the STIR futures contract into an implied bid, and wherein the implied bid comprises one of the first bid or the second bid.

4. The system of claim 1, at least one of the financial products comprising a number of deliveries of a short term interest rate (STIR) futures contract, wherein the server is further configured to combine received bids and offers for the STIR futures contract into an implied offer, and wherein the implied offer comprises the received offer.

5. The system of claim 3 or claim 4, wherein the at least one financial product comprising a number of deliveries of a STIR future contract is selected from the group consisting of strips, packs, bundles, and condors.

6. A system for facilitating trading of financial products, the system comprising:
a server at which the financial products are actively traded; and
an interface in communication with the server, the interface being configured to enable at least one of a bid and an offer for a financial product to be entered,
wherein the server is configured to receive bids and offers for each financial product via the interface, each bid or offer including a price and a number of lots, and
when, for a first product, the server receives a first offer for a first number of lots at a first time and a second offer for a second number of lots at a second time, the first offer having a same price as the second offer, and when the server receives a bid for the first product having a third number of lots and the same price as the first and second offers at a third time, the third time being after both the first time and the second time, and the third number of lots being less than a sum of the first and second numbers of lots, the server is configured to divide the received bid into a first partial bid and a second partial bid by respectively allotting the third number of lots into a fourth number of lots and a fifth number of lots, wherein the fourth and fifth numbers are respectively determined to be in a same relative proportion as the first and second numbers, and wherein a sum of the fourth and fifth numbers is equal to the third number; and
wherein the server is further configured to match the first offer to the first partial bid and to match the second offer to the second partial bid, and to execute trades respectively corresponding to the matched offers and partial bids.

7. The system of claim 6, wherein when a trade is executed such that, for a given offer, a number of lots actually traded is less than the number of lots included in the given offer, the server is configured to retain an open offer including a remaining number of untraded lots.

8. The system of claim 6, at least one of the financial products comprising a number of deliveries of a short term interest rate (STIR) futures contract, wherein the server is further configured to combine received bids and offers for the STIR futures contract into an implied offer, and wherein the implied offer comprises one of the first offer or the second offer.

9. The system of claim 6, at least one of the financial products comprising a number of deliveries of a short term interest rate (STIR) futures contract, wherein the server is further configured to combine received bids and offers for the STIR futures contract into an implied bid, and wherein the implied bid comprises the received bid.

10. The system of claim 8 or claim 9, wherein the at least one financial product comprising a number of deliveries of a STIR future contract is selected from the group consisting of strips, packs, bundles, and condors.

11. A system for facilitating trading of financial products, the system comprising:
a server at which the financial products are actively traded; and
an interface in communication with the server, the interface being configured to enable at least one of a bid and an offer for a financial product to be entered,
wherein the server is configured to receive bids and offers for each financial product via the interface, each bid or offer including a price and a number of lots, and
when, for a first product, the server receives N bids at N different times, each of the N bids having a same price, and when the server receives an offer for the first product after all N bids have been received, the offer including a number of lots that is less than a sum of the numbers of lots of the N received bids, the server is configured to divide the received offer into N partial offers by respectively allotting the offered number of lots according to a same relative proportion as the corresponding numbers of lots included in each of the N bids; and
wherein the server is further configured to match each of the N bids to a corresponding one of the N partial offers, and to execute trades corresponding to the matched bids and partial offers.

12. The system of claim 11, wherein when a trade is executed such that, for a given bid, a number of lots actually traded is less than the number of lots included in the given bid, the server is configured to retain an open bid including a remaining number of untraded lots.

13. The system of claim 11, at least one of the financial products comprising a number of deliveries of a short term interest rate (STIR) futures contract, wherein the server is further configured to combine received bids and offers for the STIR futures contract into an implied bid, and wherein the implied bid comprises one of the N received bids.

14. The system of claim 11, at least one of the financial products comprising a number of deliveries of a short term interest rate (STIR) futures contract, wherein the server is further configured to combine received bids and offers for the STIR futures contract into an implied offer, and wherein the implied offer comprises the received offer.

15. The system of claim 13 or claim 14, wherein the at least one financial product comprising a number of deliveries of a STIR future contract is selected from the group consisting of strips, packs, bundles, and condors.

16. A system for facilitating trading of financial products, the system comprising:
a server at which the financial products are actively traded; and
an interface in communication with the server, the interface being configured to enable at least one of a bid and an offer for a financial product to be entered,
wherein the server is configured to receive bids and offers for each financial product via the interface, each bid or offer including a price and a number of lots, and
when, for a first product, the server receives N offers at N different times, each of the N offers having a same price, and when the server receives a bid for the first product after all N offers have been received, the bid including a number of lots that is less than a sum of the numbers of lots of the N received offers, the server is configured to divide the received bid into N partial bids by respectively allotting the bidded number of lots according to a same relative proportion as the corresponding numbers of lots included in each of the N offers; and
wherein the server is further configured to match each of the N offers to a corresponding one of the N partial bids, and to execute trades corresponding to the matched offers and partial bids.

17. The system of claim 16, wherein when a trade is executed such that, for a given offer, a number of lots actually traded is less than the number of lots included in the given offer, the server is configured to retain an open offer including a remaining number of untraded lots.

18. The system of claim 16, at least one of the financial products comprising a number of deliveries of a short term interest rate (STIR) futures contract, wherein the server is further configured to combine received bids and offers for the STIR futures contract into an implied offer, and wherein the implied offer comprises one of the N received offers.

19. The system of claim 16, at least one of the financial products comprising a number of deliveries of a short term interest rate (STIR) futures contract, wherein the server is further configured to combine received bids and offers for the STIR futures contract into an implied bid, and wherein the implied bid comprises the received bid.

20. The system of claim 18 or claim 19, wherein the at least one financial product comprising a number of deliveries of a STIR future contract is selected from the group consisting of strips, packs, bundles, and condors.

21. A method of trading a financial product, comprising the steps of:
receiving a first bid for the financial product at a first time, the first bid including a first number of lots and a price;
receiving a second bid for the financial product at a second time, the second bid including a second number of lots and a same price as the price included in the first bid;
receiving an offer for the financial product at a third time, the third time occurring after both the first time and the second time, the offer including a third number of lots and the same price as the price included in each of the first and second bids, and the third number being less than a sum of the first and second numbers;
dividing the received offer into a first partial offer and a second partial offer by allotting the third number of lots into a fourth number of lots and a fifth number of lots, wherein the fourth and fifth numbers are respectively determined to be in a same relative proportion as the first and second numbers, and wherein a sum of the fourth and fifth numbers is equal to the third number;
matching the first bid to the first partial offer;
matching the second bid to the second partial offer; and
executing trades corresponding to the matched bids and partial offers.

22. The method of claim 21, wherein when a trade is executed such that, for a given bid, a number of lots actually traded is less than the number of lots included in the given bid, the method further comprises the step of retaining an open bid including a remaining number of untraded lots.

23. The method of claim 21, at least one of the financial products comprising a number of deliveries of a short term interest rate (STIR) futures contract, wherein the method further comprises the step of combining received bids and offers for the STIR futures contract into an implied bid, and wherein the implied bid comprises one of the first bid or the second bid.

24. The method of claim 21, at least one of the financial products comprising a number of deliveries of a short term interest rate (STIR) futures contract, wherein the method further comprises the step of combining received bids and offers for the STIR futures contract into an implied offer, and wherein the implied offer comprises the received offer.

25. The method of claim 23 or claim 24, wherein the at least one financial product comprising a number of deliveries of a STIR future contract is selected from the group consisting of strips, packs, bundles, and condors.

26. A method of trading a financial product, comprising the steps of:
receiving a first offer for the financial product at a first time, the first offer including a first number of lots and a price;
receiving a second offer for the financial product at a second time, the second offer including a second number of lots and a same price as the price included in the first offer;
receiving a bid for the financial product at a third time, the third time occurring after both the first time and the second time, the bid including a third number of lots and the same price as the price included in each of the first and second offers, and the third number being less than a sum of the first and second numbers;
dividing the received bid into a first partial bid and a second partial bid by allotting the third number of lots into a fourth number of lots and a fifth number of lots, wherein the fourth and fifth numbers are respectively determined to be in a same relative proportion as the first and second numbers, and wherein a sum of the fourth and fifth numbers is equal to the third number;
matching the first offer to the first partial bid;
matching the second offer to the second partial bid; and
executing trades corresponding to the matched offers and partial bids.

27. The method of claim 26, wherein when a trade is executed such that, for a given offer, a number of lots actually traded is less than the number of lots included in the given offer, the method further comprises the step of retaining an open offer including a remaining number of untraded lots.

28. The method of claim 26, at least one of the financial products comprising a number of deliveries of a short term interest rate (STIR) futures contract, wherein the method further comprises the step of combining received bids and offers for the STIR futures contract into an implied offer, and wherein the implied offer comprises one of the first offer or the second offer.

29. The method of claim 26, at least one of the financial products comprising a number of deliveries of a short term interest rate (STIR) futures contract, wherein the method further comprises the step of combining received bids and offers for the STIR futures contract into an implied bid, and wherein the implied bid comprises the received bid.

30. The method of claim 28 or claim 29, wherein the at least one financial product comprising a number of deliveries of a STIR future contract is selected from the group consisting of strips, packs, bundles, and condors.

31. A method of trading a financial product, comprising the steps of:
receiving N bids for the financial product, each of the N bids including a respective number of lots and a same price;
receiving an offer for the financial product after all of the N bids have been received, the offer including a same price as the price included in each of the N bids and a number of lots that is less than a sum of the numbers of lots included in the N bids;
dividing the received offer into N partial offers by allotting the offered number of lots according to a same relative proportion as the corresponding numbers of lots included in each of the N bids;
matching each of the N bids to a corresponding partial offer; and
executing trades corresponding to the matched bids and partial offers.

32. The method of claim 31, wherein when a trade is executed such that, for a given bid, a number of lots actually traded is less than the number of lots included in the given bid, the method further comprises the step of retaining an open bid including a remaining number of untraded lots.

33. The method of claim 31, at least one of the financial products comprising a number of deliveries of a short term interest rate (STIR) futures contract, wherein the method further comprises the step of combining received bids and offers for the STIR futures contract into an implied bid, and wherein the implied bid comprises one of the N received bids.

34. The method of claim 31, at least one of the financial products comprising a number of deliveries of a short term interest rate (STIR) futures contract, wherein the method further comprises the step of combining received bids and offers for the STIR futures contract into an implied offer, and wherein the implied offer comprises the received offer.

35. The method of claim 33 or claim 34, wherein the at least one financial product comprising a number of deliveries of a STIR future contract is selected from the group consisting of strips, packs, bundles, and condors.

36. A method of trading a financial product, comprising the steps of:
receiving N offers for the financial product, each of the N offers including a respective number of lots and a same price;
receiving a bid for the financial product after all of the N offers have been received, the bid including a same price as the price included in each of the N offers and a number of lots that is less than a sum of the numbers of lots included in the N offers;
dividing the received bid into N partial bids by allotting the offered number of lots according to a same relative proportion as the corresponding numbers of lots included in each of the N offers;
matching each of the N offers to a corresponding partial bid; and
executing trades corresponding to the matched offers and partial bids.

37. The method of claim 36, wherein when a trade is executed such that, for a given offer, a number of lots actually traded is less than the number of lots included in the given offer, the method further comprises the step of retaining an open offer including a remaining number of untraded lots.

38. The method of claim 36, at least one of the financial products comprising a number of deliveries of a short term interest rate (STIR) futures contract, wherein the method further comprises the step of combining received bids and offers for the STIR futures contract into an implied offer, and wherein the implied offer comprises one of the N received offers.

39. The method of claim 36, at least one of the financial products comprising a number of deliveries of a short term interest rate (STIR) futures contract, wherein the method further comprises the step of combining received bids and offers for the STIR futures contract into an implied bid, and wherein the implied bid comprises the received bid.

40. The method of claim 38 or claim 39, wherein the at least one financial product comprising a number of deliveries of a STIR future contract is selected from the group consisting of strips, packs, bundles; and condors.

41. A storage medium for storing software for facilitating trading of a financial product, the software being computer-readable, wherein the software includes instructions for causing a computer to:
receive N bids for the financial product, each of the N bids including a respective number of lots and a same price;
receive an offer for the financial product after all of the N bids have been received, the offer including a same price as the price included in each of the N bids and a number of lots that is less than a sum of the numbers of lots included in the N bids;
divide the received offer into N partial offers by allotting the offered number of lots according to a same relative proportion as the corresponding numbers of lots included in each of the N bids;
match each of the N bids to a corresponding partial offer; and
execute trades corresponding to the matched bids and partial offers.

42. The storage medium of claim 41, wherein when a trade is executed such that, for a given bid, a number of lots actually traded is less than the number of lots included in the given bid, the software further comprises instructions for causing a computer to retain an open bid including a remaining number of untraded lots.

43. The storage medium of claim 41, at least one of the financial products comprising a number of deliveries of a short term interest rate (STIR) futures contract, wherein the software further comprises instructions for causing a computer to combine received bids and offers for the STIR futures contract into an implied bid, and wherein the implied bid comprises one of the N received bids.

44. The storage medium of claim 41, at least one of the financial products comprising a number of deliveries of a short term interest rate (STIR) futures contract, wherein the software further comprises instructions for causing a computer to combine received bids and offers for the STIR futures contract into an implied offer, and wherein the implied offer comprises the received offer.

45. The storage medium of claim 43 or claim 44, wherein the at least one financial product comprising a number of deliveries of a STIR future contract is selected from the group consisting of strips, packs, bundles, and condors.

46. A storage medium for storing software for facilitating trading of a financial product, the software being computer-readable, wherein the software includes instructions for causing a computer to:
receive N offers for the financial product, each of the N offers including a respective number of lots and a same price;
receive a bid for the financial product after all of the N offers have been received, the bid including a same price as the price included in each of the N offers and a number of lots that is less than a sum of the numbers of lots included in the N offers;
divide the received bid into N partial bids by allotting the offered number of lots according to a same relative proportion as the corresponding numbers of lots included in each of the N offers;
match each of the N offers to a corresponding partial bid; and
execute trades corresponding to the matched offers and partial bids.

47. The storage medium of claim 46, wherein when a trade is executed such that, for a given offer, a number of lots actually traded is less than the number of lots included in the given offer, the software further comprises instructions for causing a computer to retain an open offer including a remaining number of untraded lots.

48. The storage medium of claim 46, at least one of the financial products comprising a number of deliveries of a short term interest rate (STIR) futures contract, wherein the software further comprises instructions for causing a computer to combine received bids and offers for the STIR futures contract into an implied offer, and wherein the implied offer comprises one of the N received offers.

49. The storage medium of claim 46, at least one of the financial products comprising a number of deliveries of a short term interest rate (STIR) futures contract, wherein the software further comprises instructions for causing a computer to combine received bids and offers for the STIR futures contract into an implied bid, and wherein the implied bid comprises the received bid.

50. The storage medium of claim 48 or claim 49, wherein the at least one financial product comprising a number of deliveries of a STIR future contract is selected from the group consisting of strips, packs, bundles, and condors.
